(19) United States
(12) Patent Application Publication
(10) Pub. No.: US 2009/0220779 A1
(43) Pub. Date: Sep. 3, 2009

(54) PIEZOELECTRIC COMPONENT HAVING A MAGNETIC LAYER

(76) Inventors: Kathrin Doerr, Dresden (DE); Ludwig Schultz, Dresden (DE); Christian Thiele, Aalen (DE)

Correspondence Address: GREENBLUM & BERNSTEIN, P.L.C., 1950 ROLAND CLARKE PLACE, RESTON, VA, 20191, US

(21) Appl. No.: 12/064,713

(22) PCT Filed: Aug. 17, 2006
(86) PCT No.: PCT/EP2006/065427

§ 371 Date: Aug. 12, 2008

(30) Foreign Application Priority Data
Aug. 26, 2005 (DE) 102005041416.8

(51) Int. Cl. G11B 5/64; B32B 9/00

(52) U.S. Cl. 428/336; 428/688

(57) ABSTRACT

The invention relates to the field of ceramics and relates to a piezoelectric component having a magnetic layer, which can be used, for example, as a resistor component, as a switch element or control or memory element or as a sensor. The invention discloses a piezoelectric component having a magnetic layer, with which the electrical and magnetic properties of the thin film(s) located thereon can be modified by mechanical elongation. In embodiments, a piezoelectric component with magnetic layer which comprises the piezoelectric compound (1-x)Pb(Mg_{1/3}Nb_{2/3})O₃—(x)PbTiO₃ where x=0.2 to 0.5 or the piezoelectric compound (1-y)Pb(Zn_{1/3}Nb_{2/3})O₃—(y)PbTiO₃ where y=0 to 0.2 as a substrate with at least one magnetic thin film applied thereto which has grown epitaxially, is disclosed.

### CROSS-REFERENCE TO RELATED APPLICATION

The present application is a National Stage of PCT/EP2006/065427, filed Aug. 17, 2006, the disclosure of which is hereby expressly incorporated by reference in its entirety. The present application claims priority under 35 U.S.C. § 119 of German Patent Application No. 10 2005 041 416.8, filed Aug. 26, 2005.

### BACKGROUND OF THE INVENTION

1. Field of the Invention

The invention relates to the field of ceramics and relates to a piezoelectric component having a magnetic layer, which can be used, for example, as a resistor component, as a switch element or control or memory element or as a sensor.

2. Discussion of the Background Information

It is known that the application of biaxial strains into the crystal lattice of rare-earth manganate layers results in a change in their electric transport properties and their magnetic properties [A. J. Millis, T. Darling and A. Migliori, J. Appl. Phys. 83 1588 (1998)].

Furthermore, components are already known, with which the inverse piezoelectric effect of a thin Pb(Zr,Ti)O₃ film is used to introduce mechanical stresses into a rare-earth manganate layer. For example, La_{0.82}Sr_{0.18}MnO₃ and Pb(Zr,Ti)O₃ are deposited epitaxially one after the other onto an SrTiO₃ substrate [H. Tabata and T. Kawai, IEICE Trans. Electron., E80-C 918 (1997)]. It was possible with these components to adjust the electrical resistance of the manganate channel (typical thickness 10 nm) via the voltage applied to the piezoelectric layer (typical thickness 500 nm). A disadvantage of this embodiment is the clamping of the layers to be mechanically deformed to the relatively thick and rigid substrate (typical thickness 500 μm), which prevents the effective introduction of great mechanical stresses into the thin manganate films.

This problem is solved by components with which the mechanically active part is identical to the substrate and on which only the layer to be deformed is applied.

Thin rare-earth manganate films (La_{0.5}Sr_{0.5}MnO₃ in [D. Dale, A. Fleet, J. D. Brock and Y. Suzuki, Appl. Phys. Lett. 82 3725 (2003)] and La_{0.67}Sr_{0.33}MnO₃, SrRuO₃ in [M. K. Lee, T. K. Nath, C. B. Eom, M. C. Smoak and F. Tsui, Appl. Phys. Lett. 77 3547 (2000)] were thus directly applied on a ferroelectric single-crystal substrate (BaTiO₃). Phase transitions caused by temperature change and thus changed lattice parameters of the substrate changed the electrical resistance, the magnetization and the magnetoresistance of the rare-earth manganate films. Dale et al. also use the inverse piezoelectric effect of the substrate in order to influence the electrical resistance of the rare-earth manganate film. The disadvantages of this embodiment are the comparatively small achievable mechanical elongations of the substrate material, time-dependent deforming of the phase and the adjustment of the lattice deformation via the temperature. Moreover, the deformation can be adjusted via the temperature-dependent structural phase transitions only in discrete steps and not steplessly.

### SUMMARY OF THE INVENTION

The invention provides a piezoelectric component having a magnetic layer with which the electrical and magnetic properties of the thin film(s) located thereon can be modified by mechanical elongation.

The piezoelectric component according to the aspects of the invention can be used as a resistor component, a switch, control or memory element, or a sensor.

The piezoelectric component having a magnetic layer according to the invention comprises a compound (1-x)Pb(Mg_{1/3}Nb_{2/3})O₃—(x)PbTiO₃ where x=0.2 to 0.5 or a compound (1-y)Pb(Zn_{1/3}Nb_{2/3})O₃—(y)PbTiO₃ where y=0 to 0.2 as a substrate with at least one magnetic thin film applied thereto which has grown epitaxially.

Within the scope of the invention, the term “epitaxially” means an ordered crystal growth with fixed relation between the crystal orientations of layer and substrate.

This generally occurs when the lattice constants of layer and substrate coincide within a tolerance range or are in an integer ratio to one another and when, moreover, a production method selected with respect to the growth temperature, the growth rate and further parameters is used for the layer.

The compounds may have a single crystal or have a polycrystalline structure.

In embodiments, the compound (1-x)Pb(Mg_{1/3}Nb_{2/3})O₃-(x)PbTiO₃ where x=0.25 to 0.29 is a single crystal, preferably x=0.28, or the compound (1-y)Pb(Zn_{1/3}Nb_{2/3})O₃—(y)PbTiO₃ where y=0.04 to 0.07 is a single crystal.

Furthermore in embodiments, the magnetic thin film may have a ferromagnetic rare-earth manganate thin film, preferably of a material having the general formula R₁₋ₓAₓMnO_{3+d}, where R may be selected from La, a rare-earth element, Y or a mixture of several of these elements; A may be selected from Sr, Ca, Ba, Pb, Ce, or a non-trivalent metal; and d=−0.1 to 0.05. More preferably, the ferromagnetic rare-earth manganate thin film comprises La_{0.7}Sr_{0.3}MnO₃ or La_{0.8}Sr_{0.2}MnO₃.

In even further embodiments, several magnetic thin films may be present one above the other, wherein all magnetic thin films having grown epitaxially. Preferably, a magnetic thin film with a different composition is present over a magnetic thin film, and/or two or more different magnetic thin films alternately one above the other are present, and/or the magnetic thin films are separated by an insulator layer. Preferably, the insulator layers are epitaxial.

In other embodiments, an intermediate layer is may be present between the substrate and the magnetic thin film, preferably, the intermediate layer being a conductive layer or a buffer layer and the intermediate layer being epitaxial.

It is also an aspect of the invention if the magnetic thin film covers the substrate only partially.

It is furthermore an aspect of the invention if the magnetic thin film has a thickness of 3 nm to 50 nm.

The invention comprises the compound Pb(Mg_{1/3}Nb_{2/3})(₃-PbTiO₃ (PMN-PT) or Pb(Zn_{1/3}Nb_{2/3})O₃—PbTiO₃ (PZN-PT), on which a magnetic, preferably a ferromagnetic rare-earth manganate thin film is deposited. The compounds PMN-PT or PZN-PT can thereby be present as single crystal or have a polycrystalline structure. The piezoelectric single crystals show ultralarge elongation values of up to 1.7% [S.-E. Park and T. R. Shrout, J. Appl. Phys. 82 1804 (1997)] and are therefore particularly preferred. The magnetic thin film may be grown epitaxially. The magnetic thin film may have contacts for supplying a constant current as well as voltage tap connections. Furthermore, an electrode layer may be applied on the side of the piezoelectric substrate facing away from the magnetic thin film. A voltage and thus an electric field can thus be applied to the piezoelectric substrate via another contact on the magnetic thin film and via a contact on the electrode layer.

Preferably, the piezoelectric substrate comprises a material having the formula (1-x)Pb(Mg_{1/3}Nb_{2/3})O₃—(x)PbTiO₃ where x=0.2 to 0.5 or (1-y)Pb(Zn_{1/3}Nb_{2/3})O₃-(y)PbTiO₃ where y=0 to 0.2. A preferred material within these ranges is (1-x)Pb(Mg_{1/3}Nb_{2/3})O₃—(x)PbTiO₃ where x=0.25 to 0.29, even more preferred where x=0.28, and/or (1-y)Pb(Zn_{1/3}Nb_{2/3})O₃—(y)PbTiO₃ where y=0.04 to 0.07.

With the application of an electric field to the piezoelectric substrate, this substrate changes its lattice constant due to the inverse piezoelectric effect. As a rule, the substrate expands parallel to the direction of the electric field and shrinks in the directions perpendicular thereto. Through the variation of the piezoelectric voltage applied, the size of the deformation can be adjusted steplessly and reversibly. A hysteretic behavior can thereby occur.

In exemplary implementations, a thin magnetic film is present on the piezoelectric single-crystal substrate. This thin magnetic film is deformed like the crystal lattice of the single-crystal substrate. Through the biaxial crystal lattice strain thereby generated, the electrical resistance, the size of the magnetization and the ferromagnetic order temperature of the film are changed. In contrast to the known components, these values can be adjusted steplessly and in wide ranges through the continuously adjustable lattice strain of the piezoelectric substrate.

In embodiments the magnetic and in particular the rare-earth manganate thin film may be grown epitaxially on the piezoelectric substrate.

In a practical implementation, the concrete thickness of the magnetic thin film depends on the material used for the film and on the desired application. It is to be assumed thereby that particularly favorable property changes can be achieved with a thickness of the magnetic thin film in the range of 3 nm to 50 nm and that the property changes increase with reduced thickness of the thin film.

In further embodiments, the magnetic thin film preferably comprises a material having the general formula R₁₋ₓAₓMnO_{3+d}, where R is selected from La, a rare-earth element, Y, Bi, or a mixture of several of these elements; A is selected from a non-trivalent metal such as, e.g., Sr, Ca, Ba, Pb or Ce and d=−0.1 to 0.05. Preferred materials are therein La_{0.7}Sr_{0.3}MnO₃ or La_{0.8}Sr_{0.2}MnO₃.

In implementations, it has been established that the behavior of the resistance of the magnetic thin film in the magnetic field, the magnetoresistance, also changes with applied piezoelectric voltage.

According to the aspects of the invention, the inverse piezoelectric effect of a single-crystal or of a polycrystalline structure from compounds according to the invention deform the crystal lattice of a magnetic thin film present thereon which may comprise an epitaxially grown ferromagnetic rare-earth manganate thin film. Electrical resistance and magnetic properties of the magnetic thin film can be influenced thereby. In embodiments, the invention is in particular applied for regulating an electric current, for switching a magnetization and as a sensor. Likewise, application as a storage element is possible.

Furthermore, according to aspects of the invention, large biaxial tensile stresses or compressive stresses may be induced into a magnetic thin film in a steplessly controllable manner. The crystal lattice of the magnetic thin film is thus deformed, whereby the electric and magnetic properties of the magnetic thin film change. In preferred embodiments, a magnetic thin film is grown epitaxially. Thus, the component can be used to regulate electric currents, to switch magnetizations and as a sensor.

### BRIEF DESCRIPTION OF THE DRAWING

The invention is explained in more detail below based on an exemplary embodiment with reference to the accompanying drawing.

FIG. 1 depicts a component according to aspects of the invention in diagrammatic representation.

### DETAILED DESCRIPTION OF THE INVENTION

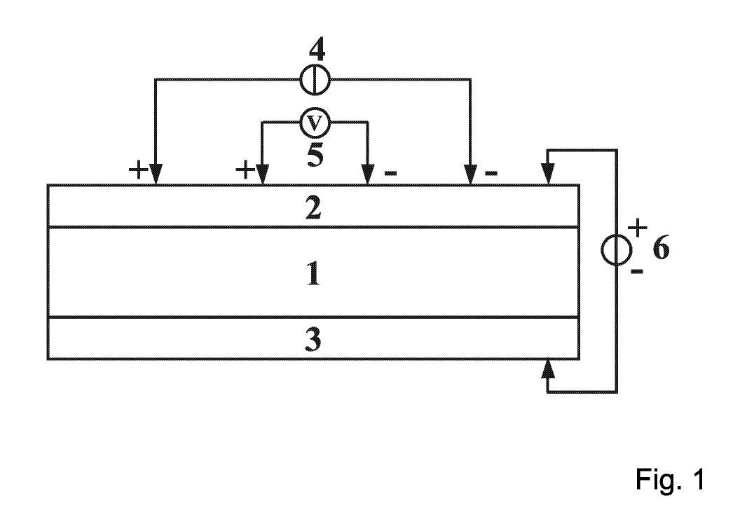

In exemplary embodiments, for example, as shown in FIG. 1, a rare-earth manganate layer 2 has grown epitaxially on a 400 μm thick single-crystal piezoelectric substrate 1 of (1-x)Pb(Mg_{1/3}Nb_{2/3})O₃—(x)PbTiO₃ where x=0.28. The rare-earth manganate layer 2 comprises La_{0.7}Sr_{0.3}MnO₃ and has a thickness of 30 nm. It was produced using a stoichiometric target by pulsed laser deposition in an atmosphere with 45 Pa oxygen. The lower electrode layer 3 comprises NiCr/Au. The rare-earth manganate layer 2 is bonded to respectively two current and voltage connections 4 and 5. The rare-earth manganate layer 2 and the lower electrode layer 3 are connected by contacts 6.

In accordance with aspects of the invention, application of an electric field to the piezoelectric substrate 1 by an electric voltage 6, the resistance of the rare-earth manganate layer 2 changes. The resistance values were thereby determined from the voltage values measured at the voltage tap connections 5 with a constant current flowing via the current tap connections 4. The resistance value of R=227Ω is reduced by 9% with the application of an electric voltage to the piezoelectric substrate 1 of 500 V. The decrease in the resistance R is approximately proportional to the voltage 6 applied. The resistance change is reversible and is also produced with the application of a voltage 6 with opposite sign. At low voltages a hysteretic behavior is discernible.

Furthermore, the magnetization of the rare-earth manganate layer 2 changes with the application of a voltage 6. At a measurement temperature of T=330 K and in a magnetic field of μ₀H=0.01 T, the magnetization M=4.3×10⁻¹⁴ V s m (M=3.4×10⁻⁵ emu) increases by approx. 20% with a voltage 6 of 400 V applied to the piezoelectric substrate 1. The increase is approximately proportional to the voltage 6, it is reversible and also results with application of a voltage 6 with opposite sign. At low voltages a hysteretic behavior is discernible.

According to further exemplary aspects of the invention, the ferromagnetic order temperature Tc of the rare-earth manganate layer 2 also changes upon the application of a voltage 6. In a magnetic field of μ₀H=0.3 T, the order temperature rises from 341 K at 0 V to 348 K at a voltage 6 of 400 V. This behavior is also reversible, the order temperature also rises with opposite sign of the voltage 6 and a hysteretic behavior is also discernible here at low voltages.

List of Reference Numbers

| | |
|---|---|
| 1 | Piezoelectric substrate |
| 2 | Magnetic layer |
| 3 | Electrode |
| 4 | Current tap connections |
| 5 | Voltage tap connections |
| 6 | Voltage |

1. A piezoelectric component having a magnetic layer, comprising a piezoelectric compound (1-x)Pb(Mg_{1/3}Nb_{2/3})O₃—(x)PbTiO₃ where x=0.2 to 0.5 or a piezoelectric compound (1-y)Pb(Zn_{1/3}Nb_{2/3})O₃—(y)PbTiO₃ where y=0 to 0.2 as a substrate with at least one magnetic thin film applied thereto which has grown epitaxially.

2. The component according to claim 1, in which the piezoelectric compound is a single crystal or comprises a polycrystalline structure.

3. The component according to claim 1, in which the piezoelectric compound (1-x)Pb(Mg_{1/3}Nb_{2/3})O₃—(x)PbTiO₃ where x=0.25 to 0.29 is a single crystal, or in which the piezoelectric compound (1-y)Pb(Zn_{1/3}Nb_{2/3})O₃—(y)PbTiO₃ where y=0.04 to 0.07 is a single crystal.

4. The component according to claim 3, in which the piezoelectric compound is (1-x)Pb(Mg_{1/3}Nb_{2/3})O₃—(x)PbTiO₃ where x=0.28.

5. The component according to claim 1, in which the at least one magnetic thin film is a at least one ferromagnetic rare-earth manganate thin film.

6. The component according to claim 5, in which the at least one ferromagnetic rare-earth manganate thin film comprises a material having the general formula R₁₋ₓAₓMnO_{3+d}, where R is selected from La, a rare-earth element, Y and a mixture of several of these elements; A is selected from Sr, Ca, Ba, Pb, Ce, and a non-trivalent metal; and d=−0.1 to 0.05.

7. The component according to claim 6, in which the at least one ferromagnetic rare-earth manganate thin film comprises La_{0.7}Sr_{0.3}MnO₃ or La_{0.8}Sr_{0.2}MnO₃.

8. The component according to claim 1, in which at least two magnetic thin films are present one above the other.

9. The component according to claim 8, in which the at least two magnetic thin films have grown epitaxially.

10. The component according to claim 8, in which a the at least two magnetic thin films have different compositions.

11. The component according to claim 8, in which two or more different magnetic thin films alternately one above the other are present.

12. The component according to claim 8, in which the at least two magnetic thin films are separated by an insulator layer.

13. The component according to claim 12, in which the insulator layers are epitaxial.

14. The component according to claim 1, in which an intermediate layer is present between the substrate and the at least one magnetic thin film.

15. The component according to claim 14, in which the intermediate layer is a conductive layer or a buffer layer.

16. The component according to claim 14, in which the intermediate layer is epitaxial.

17. The component according to claim 1, in which the at least one magnetic thin film covers the substrate only partially.

18. The component according to claim 1, in which the at least one magnetic thin film has a thickness of 3 nm to 50 nm.
